(19) United States
(12) Patent Application Publication
(10) Pub. No.: US 2026/0340715 A1
(43) Pub. Date: Oct. 29, 2026

(54) SYSTEM AND METHOD FOR IMPLEMENTING DATA PRODUCT ISOMETRICS IN AN INTERACTIVE THREE-DIMENSIONAL PLATFORM

(71) Applicant: KPMG LLP, New York, NY (US)

(72) Inventors: Danielle T. Beringer, Franklin, TN (US); Gabriel Crane, New York, NY (US)

(21) Appl. No.: 19/659,195

(22) Filed: Apr. 27, 2026

Related U.S. Application Data
(60) Provisional application No. 63/794,933, filed on Apr. 25, 2025.

(51) Int. Cl. G06Q 30/0601

(52) U.S. Cl. CPC G06Q 30/06435; G06Q 30/0624

(57) ABSTRACT

An embodiment of the present invention is directed to an innovative data products experience and interaction platform that provides business value assessments and insights into a data lifecycle and value chain. The innovative data products experience and interaction platform may support various workflows and experiences including data development and data consumer experiences. With the innovative data products experience and interaction platform, a user is able to interact with a data marketplace through linkages and integrations to streamline the data development and data discovery experiences.

### CROSS REFERENCE TO RELATED APPLICATIONS

The application claims priority to U.S. Provisional Application 63/794,933 (Attorney Docket No. 055089.0000142), filed Apr. 25, 2025, the contents of which are incorporated by reference herein in their entirety.

### FIELD OF THE INVENTION

The present invention relates to data management platforms and interactive user interfaces, and more particularly to systems and methods for implementing data product isometrics in an interactive three-dimensional platform that provides visualization and management of data product lifecycles.

### BACKGROUND

Modern data platforms generally refer to collections of tools that assist organizations in managing their data throughout its lifecycle. These platforms may be designed to simplify and streamline data infrastructure and accelerate advanced data analytics initiatives. A data product may represent a curated collection of data, metadata, semantics and templates that may be used for specific business objectives. Once created, data products may be accessed and used in data analytics and other applications.

Organizations have increasingly recognized the value of treating data as a product that goes through a lifecycle, including stages of development, certification and publication. This approach involves joining business and technical stakeholders together to manage data products from inception through deployment and ongoing maintenance. Data products may be made available through data marketplaces where users throughout an enterprise can discover and access certified data assets.

Traditional approaches to managing and visualizing data products present various challenges. Information presented to stakeholders is oftentimes overly generalized or too narrow and specific, and further isolated from relevant context. Conventional data management interfaces typically present data lifecycle information in flat, two-dimensional displays such as workflow diagrams or ETL flow visualizations. These flat representations may make it difficult for users to understand the relationships and dependencies between different components, personas and stages of the data product lifecycle.

In addition, conventional engagements in this space oftentimes involve providing deliverables that include an inventory of data products in spreadsheet format or slide presentations. However, these types of deliverables may be insufficient in meeting client needs for understanding complex data environments. Users may have difficulty absorbing and navigating through large amounts of information presented in traditional formats, and context switching between different topics or information paradigms may be cumbersome.

Furthermore, existing systems may lack the ability to serve multiple personas with different perspectives and information needs. A technology-focused user, a business-focused user and a risk analyst may each have different requirements for understanding a data product ecosystem, yet traditional interfaces may not readily accommodate these varying viewpoints within a unified experience.

It would be desirable, therefore, to have a system and method that could overcome the foregoing disadvantages of known systems.

### SUMMARY

According to an embodiment, the invention relates to a computer-implemented system that implements data product isometrics in an interactive platform. Embodiments of the present invention may comprise at least one of true data and synthetic data. The system comprises: an interactive three dimensional user interface that provides a plurality of synthetic data product isometrics in the isometric three-dimensional interactive interface platform; a database; and a computer server that comprises a processor that is communicatively coupled to the interactive three-dimensional user interface and the database and further configured to: receive, via the interactive three-dimensional user interface, a request for one or more data products; evaluate, via an evaluate and define stage within the interactive three-dimensional user interface, the request and define the one or more data products; build, via a development stage within the interactive three-dimensional user interface, the one or more data products and solutions; certify, via a publish stage within the interactive three-dimensional user interface, the one or more data products; publish, via the publish stage within the interactive three-dimensional user interface, the one or more data products; monitor, via the publish stage within the interactive three-dimensional user interface, the one or more data products; and feature the one or more data products in an interactive Data Marketplace.

According to an embodiment, the invention relates to a computer-implemented system that implements data product isometrics in an interactive platform. The system comprises: an interactive user interface that provides a plurality of data product isometrics in an interactive three-dimensional platform; a database; and a computer server comprising a processor communicatively coupled to the interactive user interface and the database, the processor configured to: engage, via an interactive three-dimensional interface, a data marketplace; search, via a platform and experience stage within the interactive three-dimensional interface, for one or more data products; view, via the platform and experience stage within the interactive three-dimensional interface, one or more data product profiles associated with the one or more data products; add, via the platform and experience stage within the interactive three-dimensional interface, the one or more data products to a checkout interface; validate, via a data product stage within the interactive three-dimensional interface, for permissibility of product access for the one or more data products; deliver, via the data product stage within the interactive three-dimensional interface, the one or more data products; and receive, via a governance stage within the interactive three-dimensional interface, data product feedback and recommendations.

According to another embodiment, the invention also relates to a computer-implemented method that implements synthetic data product isometrics in an interactive platform, and to a computer-readable medium containing program instructions for executing a method for implementing synthetic data product isometrics.

An embodiment of the present invention is directed to systems and methods for implementing data product isometrics in an interactive three-dimensional platform. The platform presents data product lifecycle information through isometric visualizations that enable users to perceive relationships and dependencies between components, personas, and stages of the data product lifecycle. The interactive three-dimensional interface supports multiple user personas with customized views and information relevant to respective roles, and provides selectable information layers that may be toggled to display different types of contextual information including value assessments, technology details, risk indicators, and capability scoring. The platform organizes data product development into stages including an evaluate and define stage, a development stage, and a publish stage, with completed data products featured in an interactive data marketplace where users may search for, view, and obtain certified data assets through a self-service experience. The system further supports capability heat map overlays displaying maturity scores, customizable text labels and content, and linking and integration to external systems.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 illustrates an exemplary user interface, according to an embodiment of the present invention.

FIG. 3 illustrates an exemplary user interface, according to an embodiment of the present invention.

FIG. 4 is an exemplary flow diagram, according to an embodiment of the present invention.

FIG. 5 illustrates an exemplary user interface, according to an embodiment of the present invention.

FIG. 6 illustrates an exemplary user interface, according to an embodiment of the present invention.

FIG. 7 is an exemplary system diagram, according to an embodiment of the present invention.

FIG. 8 illustrates an exemplary user interface, according to an embodiment of the present invention.

FIG. 9 illustrates an exemplary user interface, according to an embodiment of the present invention.

FIG. 10 illustrates an exemplary user interface, according to an embodiment of the present invention.

FIG. 11 illustrates an exemplary user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to an innovative data products experience and interaction platform that provides business value assessments and insights into a data lifecycle and value chain. According to an embodiment of the present invention, a data product may represent a curated collection of data, metadata, semantics and templates that may be used to solve business problems. Data products may be reusable, reliable and easily accessible. In addition, data products may be curated and maintained to be used in specific business objectives. Once created, data products may be available through a Data Marketplace where they may be accessed and used in data analytics and other applications.

The innovative data products experience and interaction platform may support various workflows including data development and data consumer experiences. With the innovative data products experience and interaction platform, a user is able to interact with a data marketplace to streamline data development and data discovery.

An embodiment of the present invention may support a data product build experience including various stages such as evaluate and define; development; and publish. For example, a requester or product portfolio manager may evaluate and define data products through requirements and standards. A product owner may develop a data product as defined by data product components through a development and testing environment. Data products may be released to an enterprise. The data products may then be made available through a Data Marketplace.

In addition, an embodiment of the present invention provides a platform experience that enables interaction with data products using the Data Marketplace through various stages such as platform and experience; data product; and governance. A user / shopper may navigate through a marketplace experience to data delivery and also provide feedback towards a governance platform. With this navigation, the system may continually populate and monitor the stages of a data product life cycle. With the data marketplace of an embodiment of the present invention, a self-service experience is provided that is not available or even feasible with current systems.

Interactive data layers may provide various types of analytics, metrics and indicators within the interactive interface. This may include rendering data from a capability matrix and generating value determinations. The capability matrix may include: data accessibility; infrastructure accessibility; time to market / time to value and development environment accessibility and operations.

An embodiment of the present invention is directed to providing business value assessments that may be adjusted with a set of value levers relevant to a data value chain. The set of value levers may include a combination of: cost reduction; workforce refactoring; support regulatory compliance; technology simplification; data-driven decision support; new revenue generation; shortened time to insights; competitive advantage; operational excellence; and speed to market.

An embodiment of the present invention is directed to producing a curated stack of services and accelerators through a modern data platform along with integrations and links to a wide range of data and services, e.g., a service catalog with scripts, code, starter kits for clients. With a data analytics engagement, an entity may provide reusable customized accelerators and code through a code repository. For example, an embodiment of the present invention may leverage an accelerator library that includes custom code that may then be shared with clients. This may include intelligent forecasting, industry specific accelerators, etc. The modern data platform may be a reference architecture, including guidance and suggestions on what technology to use and how to optimally use the technology.

An embodiment of the present invention is directed to providing an interactive interface that approaches data like a physical product that goes through a life cycle, certification, etc. With an embodiment of the present invention, business stakeholders may gain an enhanced and insightful understanding of and experience with a data product life cycle.

An embodiment of the present invention is directed to a customized data products experience that provides an improved understanding of data products and their environments.

An embodiment of the present invention is directed to an innovative interaction in three dimensions through isometric data tools that provides access to contextual and targeted data. The innovative interaction in three dimensions provides a unique and comprehensive view of a data product’s life cycle in a customized, bespoke and configurable manner. This enhances the way data management software providers allow users to interact with data lifecycle processes and identify relationships between people and how data is handled. This experience may be part of a set of services and may be hosted by a provider or accessed through a subscription.

An embodiment of the present invention provides a wide range of user interactions in 3D isometric experiences. The user interaction experiences may include: a user shopping (e.g., consumer) experience and a back office development (e.g., presenter/manager) experience. The user shopping experience may help a user intelligently search and find relevant and useful data products and then make the data products available for their team. The user may interact with various parts of the ecosystem and drill down as needed to access more information. The interactive user experiences may include multiple layers and/or overlays of information that support various personas and types of analytics and data. For example, the various personas may include a technology persona, a business persona, a risk analyst persona, etc.

The interactive experience enables users to access and interact with relevant information within a contextually rich and customized environment. This is in contrast to traditional approaches and data management providers where information presented is oftentimes overly generalized or too narrow / specific and also isolated from relevant context.

The innovative interaction interface provides additional information that is not readily available or easily accessible in a flat two dimensional display. The innovative interaction interface provides an ability to access various types of data simultaneously within a contextual environment where respective positioning and relationships may be illustrated (as shown by arrows and connections). The innovative interaction interface also provides an ability to context switch as desired that is generally unavailable with current systems. This provides an ability to jump or toggle from item to item within a topic across information paradigms and various layers including risks, value levers, etc.

An embodiment of the present invention is directed to managing and creating multiple versions of consumer and development experiences. This may involve a healthcare client, a manufacturing client, etc. For example, a business lead may interact with an embodiment of the present invention with a business outcomes oriented focus. In this example, the business lead may be interested in a supply chain of creating data products, involved entities, corresponding responsibilities, an amount of resources, etc. According to another example, an IT organization may be interested in analyzing business needs to drive high value outcomes.

An embodiment of the present invention is directed to quantifying the data value chain based on an innovative rubric / approach to help entities determine various scenarios, e.g., issues relating to regulatory controls and governance. An embodiment of the present invention is directed to generating and applying a formula or a set of formulas that is repeatable to determine data value change. Through the interactive interface, a user may interact with various stackable layers that provide a unique perspective, e.g., a value view. For example, the value view may display an indicator that illustrates how to achieve a decrease / an increase in time to market by a percentage, e.g., 10%. Other metrics and business goals may be supported.

Other interactive experiences, calculation and valuation tools may be provided, including a heatmap overlay. In addition, an embodiment of the present invention may dynamically provide a checklist for enterprises, such as, e.g., capability inventory, functional / technical capability inventory, marketplace checkout, delivery automation, etc. According to another example, an overlay may provide an indication of maturity (e.g., scale of 1 to 5).

An embodiment of the present invention is directed to a data product lifecycle as an exemplary illustration and may be used for other applications, such as a software development lifecycle.

An embodiment of the present invention may be directed to experience management features and functionality.

The system enables individual users to create and configure custom information layers for display within a user interface. Each custom layer may include user-defined iconography, pop-up information associated with selected layer elements, and reference links to external materials, documents, resources, or software applications. The custom layer may thereby provide a configurable overlay through which user-specific visual indicators, contextual data, and external system references are selectively presented.

The system enables a user to export information associated with an isometric experience into a comma-separated values (CSV) file. The exported information may include object text labels, story-related information, and layer-associated data. The system may further permit a user to modify the CSV file and import the modified CSV file into the same or a different isometric experience to overwrite corresponding stored values. This functionality supports external editing, transfer, and synchronization of experience-specific data across multiple experiences.

The system permits an individual isometric experience to be designated as public, thereby making the experience accessible to any user authorized to access the isometric web application. In addition, the system enables creation of a new isometric experience from a template based on an existing experience, such that one or more structural, visual, informational, or configuration elements of the existing experience are replicated in the new experience. Further, the system provides fine-grained permission controls for an isometric experience, including configurable access, editing, and administrative rights, as well as transfer of ownership. Such permissions may be managed by an experience owner, an application administrator, or both.

An embodiment of the present invention may be directed to application management features and functionality. The system integrates with an enterprise user directory to perform user authentication and manage identity-based access control. The system provides a profile listing interface configured to display users and respective isometric experiences associated with each user. The system includes an administrative console for managing application-level permissions, roles, and user access settings.

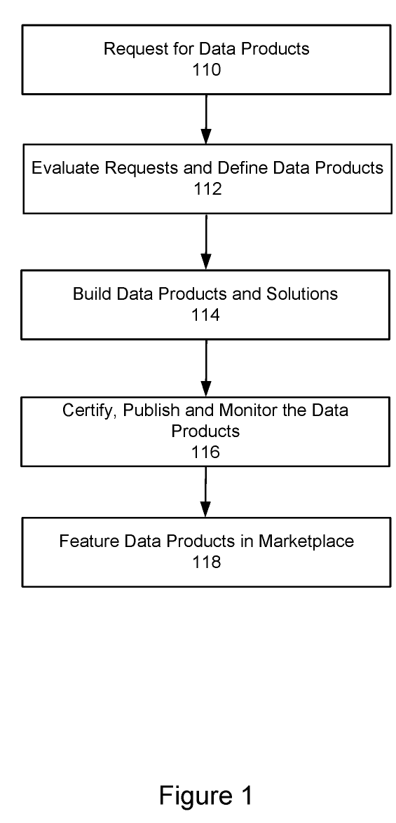

FIG. 1 is an exemplary flow diagram, according to an embodiment of the present invention. FIG. 1 illustrates a data product development experience within an interactive interface in three dimensions. At step 110, a request for data products may be received. At step 112, the request may be evaluated and data products may be defined. At step 114, data products and solutions may be built. At step 116, the data products may be certified, published and monitored. At step 118, the data products may be featured in a data marketplace. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, a request for data products may be received. The creation of a new data product may originate from one of several triggers, which may relate to business needs and lead to finding value in data with an expectation of repeat use and high quality standards. A new product request may be typically raised by a member of the business community. A product change or enhancement request may be typically raised by a member of the business community. A product submission may be made by a data product producer. A portfolio gap may be defined by a data product portfolio manager. Regardless of origin, triggers may flow into a funnel that may be reviewed for best fit and then line up next steps for development activity.

At step 112, the request may be evaluated and data products may be defined. For example, a product portfolio manager may assess a company’s data product portfolio in several ways including periodically or regularly to track trends and ensure business alignment, and on-demand which may be in response to user feedback. This role may involve examining requests for new or updated data products, accounting for similarities, alignment with the company’s goals, potential value, return on investment (ROI), required effort, priority, risks and ownership. Defining data product requirements may involve understanding the requester’s needs, business context, data policies, regulations, team development standards, etc.

At step 114, data products and solutions may be built. Data products may be made of not only data, but also complimentary content and structural components to keep the data up to date and rules to secure and monitor the data. These categories of components – inputs, content, delivery methods, and management rules – may be expressed as data pipelines, quality standards, metadata and data enrichment, filtering, and version control management of the data. Consistent data product build standards increase quality, reliability, and useability. This further enhances trust from the user base and allows for efficient back office operations.

At step 116, the data products may be certified, published and monitored. Publishing a data product to production may involve collaboration among product owner, product portfolio manager and product engineering teams. They may iterate on the product, aligning business goals with technical execution using production tools to refine for scalability, performance, and security. This ensures that business objectives and technical standards are met. Key production controls, such as certification, ensure compliance and governance, while monitoring tools may track performance and detect anomalies in real-time. This approach fosters continuous improvement, enabling a smooth, reliable deployment into the production environment while minimizing risks and maintaining efficiency.

At step 118, the data products may be featured in a data marketplace. The data product requested, defined, built and published may sit alongside other certified data assets and solutions, ready to be discovered in a self-service manner by users throughout the enterprise. High quality, fresh and trusted data products leave analysts more time to analyze, visualize, and story-tell rather than clean and prepare. In addition, consumers of data spend less time questioning where data is coming from or how it was derived, and more time absorbing and leveraging the insights provided by the analysis.

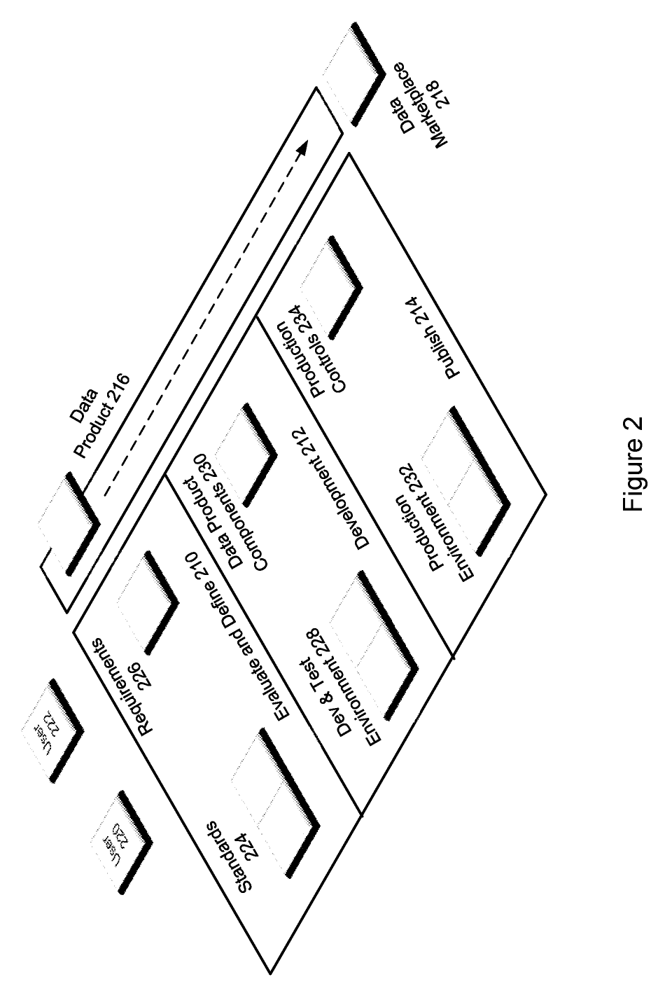

FIG. 2 illustrates an exemplary user interface, according to an embodiment of the present invention. FIG. 2 illustrates a data development platform where a user, as shown by User 220, User 222, may interact in three dimensions using isometric components. The data development platform provides an interactive three-dimensional interface where users may interact with various components organized across multiple stages of data product development.

As shown in FIG. 2, multiple components may be grouped by Evaluate and Define 210, Development 212, Publish 214 and Data Product 216.

Evaluate and Define 210 represents a first stage where data product requirements may be assessed and defined. Within Evaluate and Define 210, a Standards 224 provides guidelines and specifications that govern data product development. Standards 224 may include data product standards, development standards, and enterprise standards. Requirements 226 may include: business, development and enterprise.

Development 212 represents a second stage where data products may be constructed. Development and Testing Environment 228 may include: infrastructure, tools, and services. Data Product Components 230 may encompass various elements that comprise a data product. Data Product Components 230 may include inputs, delivery mechanisms, content, and governance rules.

Publish 214 represents a third stage where data products may be released to an enterprise. Publish 214 includes a Production Environment 232, which provides infrastructure, tools, and services for deploying data products in a production setting. Production Controls 234 operate within Publish 214 to manage certification and monitoring of data products to ensure compliance and quality standards are maintained.

Data Product 216 represents a data product as the data product progresses through the various stages of the development lifecycle. The system tracks and displays the state of Data Product 216 throughout Evaluate and Define 210, Development 212, and Publish 214 stages.

Data Marketplace 218 represents a destination where completed and certified data products may be made available for discovery and consumption by users throughout an enterprise. Data Marketplace 218 provides a self-service experience where users may search for, access, and utilize published data products.

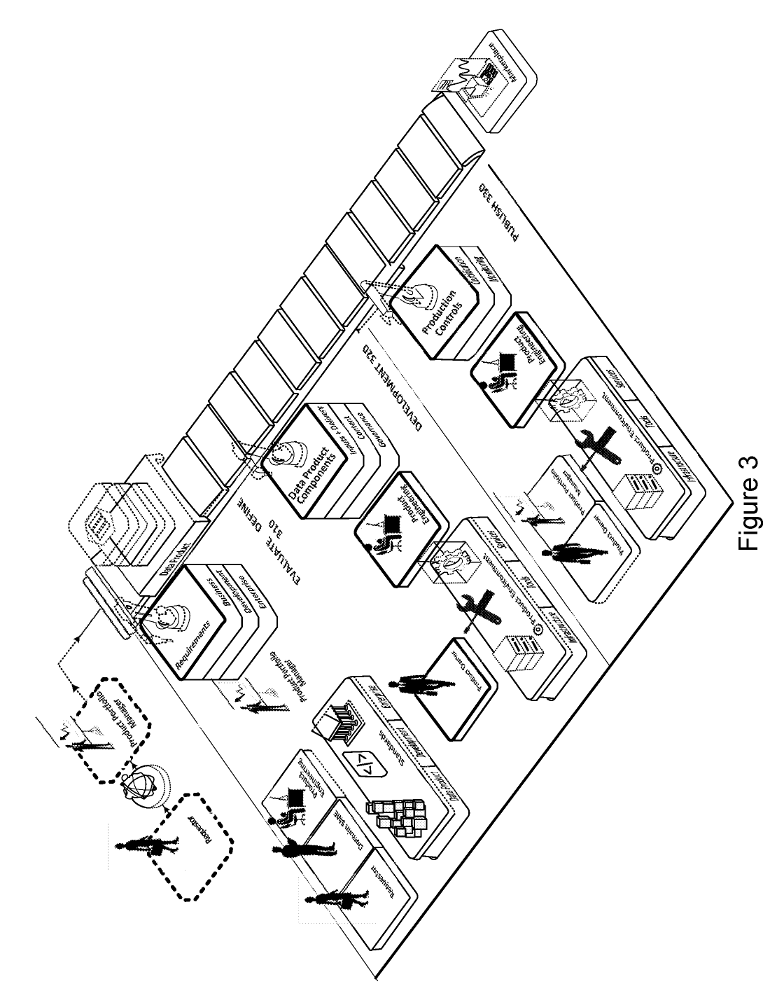

FIG. 3 illustrates an exemplary development user interface, according to an embodiment of the present invention. FIG. 3 illustrates a more detailed data development platform where various users may interact in three dimensions using isometric components. FIG. 3 provides a detailed view of the data product lifecycle workflow organized into distinct stages including an Evaluate Define stage, a Development stage, and a Publish stage, with a Marketplace component at the end of the workflow.

The system supports multiple personas that may interact with the platform. The multiple personas may include a Requestor, a Product Portfolio Manager, a Product Owner, a Domain SME (Subject Matter Expert), and Product Engineering representatives. Each persona may have customized views and information relevant to a respective role. For example, a technology persona may view technical infrastructure details, a business persona may view business alignment and value metrics, and a risk analyst persona may view compliance and governance information. The system accommodates these varying viewpoints within a unified experience through the interactive three-dimensional interface.

At Evaluate and Define 310, the Product Portfolio Manager may interact with Requirements (e.g., business, development, enterprise), other users or agents (e.g., Requestor, Domain SME, Product Engineering) and standards (e.g., data product, development, enterprise). At Development 320, Product Owner may interact with Product Environment (e.g., infrastructure, tools, services) and Product Engineering. Data Product Components may include inputs and delivery, content and governance. At Publish 330, additional interactions may involve Product Environment (e.g. infrastructure, tools, services) and Production Controls (e.g., certification, monitoring). The Data Product may then enter the Marketplace.

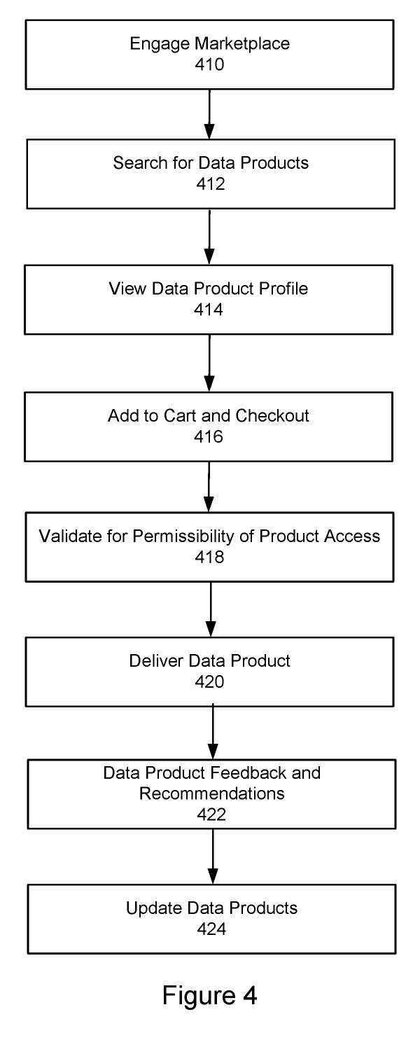

FIG. 4 is an exemplary flow diagram, according to an embodiment of the present invention. At step 410, a user may engage with a data marketplace. At step 412, the user may search for data products. At step 414, the user may view data product profiles. At step 416, the data products may be added to a cart and a checkout process may be initiated. At step 418, product access permissibility may be validated. At step 420, the data product may be delivered. At step 422, data product feedback and recommendations may be received. At step 424, data products may be updated. While the process of FIG. 4 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 410, a user may engage with a data marketplace. According to an exemplary illustration, the user may represent a lead data analyst at a mid-sized company. The user may need high quality data as soon as possible to analyze, which may then be used to inform the company’s business decisions. The user may have been asked to find any material and use judgement to determine whether the data is a good fit. The user may begin a search at the company’s enterprise data marketplace.

At step 412, the user may search for data products. The user may search for data products and analytic accelerators with text and terms the user is familiar with. AI-enabled search features may allow conversational search phrases and recommendations proactively pushed to the user. The results may be further refined by filtering on categories such as industry, location as well as different data types such as structured and unstructured. The user may then find a dataset that is useful for the company, application or specific need.

At step 414, the user may view data product profiles. The user may want to learn more about a data set that looks promising. By interacting with the specific product profiles, the user has access to a comprehensive view of that product, including a description of the product, its recommended use, reviews from others who have used it around the organization and its owner. In addition to business contextual information, data product profiles may be actively fed by the data’s data quality scores over time, data lineage, and permissible terms of use. Additional technical information may also be included, such as schema definition, sensitivity tags and delivery options. The live data may be previewed with security enforced based on data handling policies applied to the user’s profile. The combination of information establishes the user’s trust in the data.

At step 416, the data products may be added to a cart and a checkout process may be initiated. Comfortable that the user found the data the user wants, the user may add the data product to a cart for checkout. The checkout process may trigger a workflow that validates or verifies that the user is allowed to gain access to this data based on the user profile and the user’s intended use of the data.

At step 418, product access permissibility may be validated. If human-in-the-loop approvals are needed, the workflow may continue and request that of the product owner, or others. This may apply for cost approvals, license availability, and/or other business-specific rules.

At step 420, the data product may be delivered. With the checkout process complete, the selected data product may be delivered to the user’s data and analytics team in an automated manner. Delivery options may vary by team need and product type, including download or direct database connection.

At step 422, data product feedback and recommendations may be received. Data and Analytics Teams may influence the evolution of data products in the marketplace in multiple ways including: request new data products; provide feedback on the data products they use; and submit what they created for consideration to be added to the marketplace. Feedback may be reviewed by a Data Product Portfolio Manager to learn and make adjustments on how best to incorporate that feedback into the collection and investment priorities of the data product portfolio. Relevant topics filtered from that feedback may be brought to a governance board of diverse participants for awareness, discussion, and alignment on strategic goals.

At step 424, data products may be updated. For development and evolution of data products, business aligned professionals and technical experts may come together to define, build and iterate. The definitions of data products may be aligned to enterprise standards and domain specifics. For example, Data Operations (DataOps) engineers may build out components of data products throughout the enterprise data platform. This may include: setting up data pipelines, defining custom data quality rules, CI/CD with test automation, core solution development, metadata tagging, security rules definition and application, and marketplace profile publishing.

An embodiment of the present invention is directed to making these features and workflows available at scale to address and meet various needs and uses across multiple industries and applications.

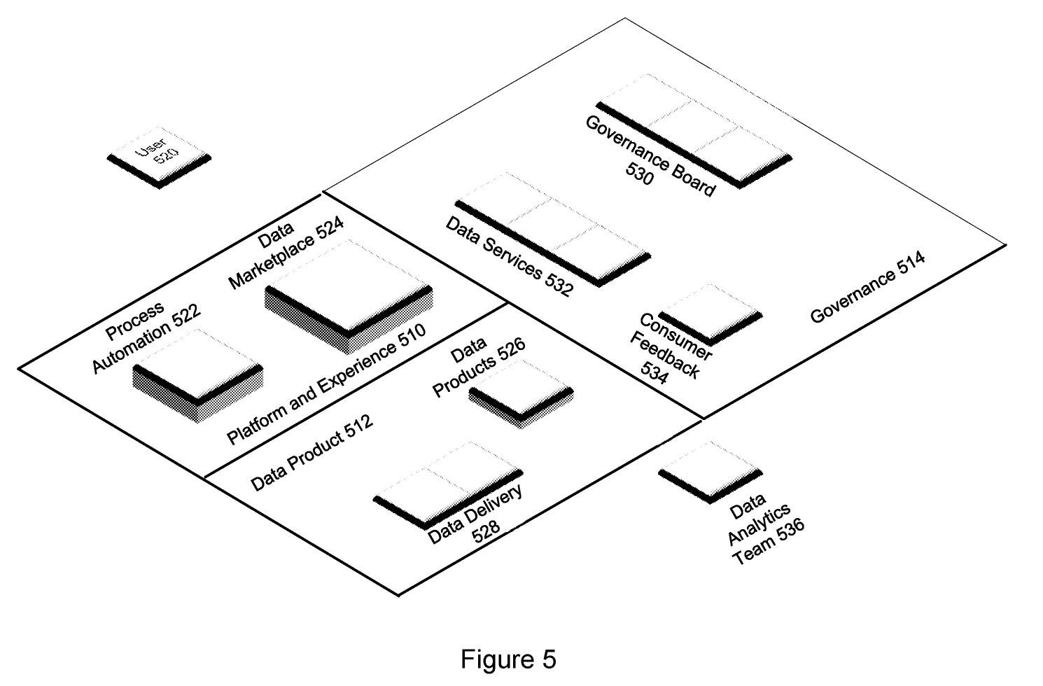

FIG. 5 illustrates an exemplary marketplace user interface, according to an embodiment of the present invention. FIG. 5 illustrates a user experience platform where a user may interact in three dimensions using isometric components related to process automation and data marketplace functionality. Process automation may include operational data warehouse functions, permission validation, delivery, deprovisioning, and data management lifecycle operations. Data marketplace functionality may include search capabilities, product profiles, and checkout processes. The data marketplace may represent an enterprise central platform and storefront for providing self-service access to data products and solutions.

FIG. 5 illustrates multiple components that may interact through Platform and Experience 510, Data Product 512 and Governance 514. As shown in FIG. 5, User 520 may interact with Process Automation 522 and Data Marketplace 524 within Platform and Experience 510; Data Products 526 and Data Delivery 528 within Data Product 512; and Governance Board 530, Data Services 532 and Consumer Feedback 534 within Governance 514. Other users and teams, such as Data Analytics Team 536, may be supported.

Data Product 512 may include data storage components and file repository structures. Data delivery mechanisms within Data Product 512 may include data views, business-to-business portal access, and communications including email delivery options.

Process Automation 522 may include: operational data warehouse, permission validation, delivery, deprovisioning and data management lifecycle. Data Marketplace 524 may include: search, product profiles and checkout. Data Products 526 may include: data storage and file repository. Data Delivery 528 may include: data views, B2B portal and communications/email. Data Services 532 may include: Generative AI, Quality Engine, Policy Engine and Data Catalog. Consumer Feedback 534 may include: submissions, and user reviews. Governance Board 530 may include: steering committees, enterprise data architects, domain SMEs and data stewards.

Data Marketplace 524 may represent an enterprise’s central platform and storefront for providing self-service access to data products and solutions. Data Marketplace 524 may provide an ability to: discover best-in-class data and accelerators; understand content at a glance; provide connections to a broader data and analytics community; and elevate trust in where data comes from and how it is prepared for use.

Generative AI enhanced search may provide intelligent recommendations dynamically provided to users based on their needs, activity history, data product popularity, user profile information, etc.

Quality Engine may represent a central source of enterprise Data Quality rules and domain-specific Data Quality Standards. This may also represent historical reference location for raw and curated Data Quality checks that have been performed.

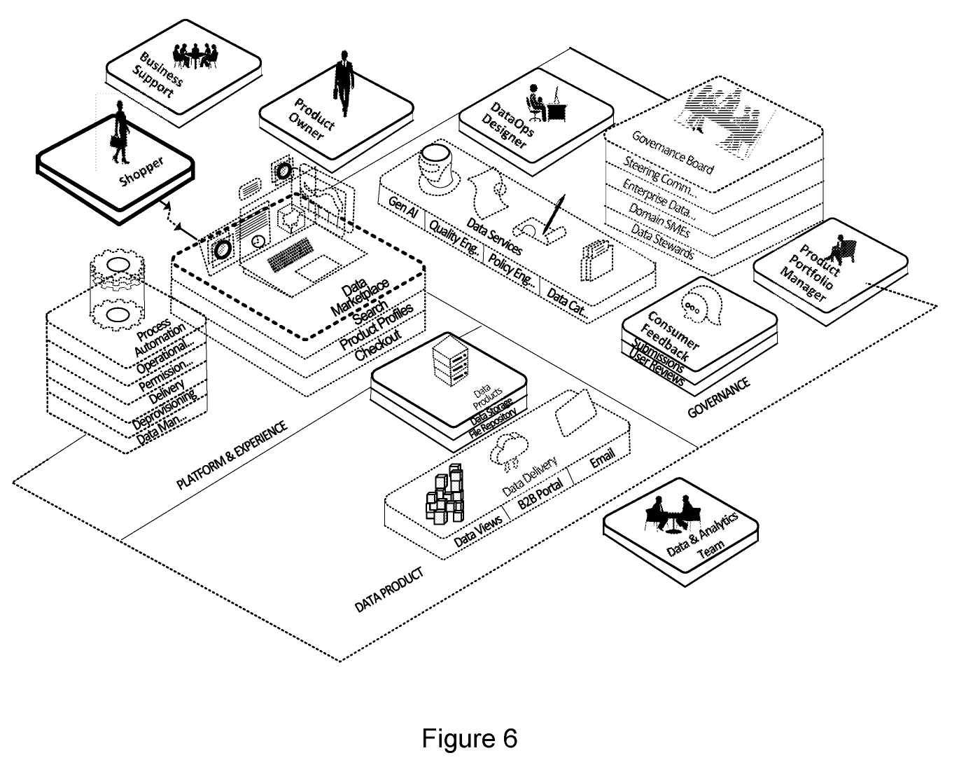

FIG. 6 illustrates exemplary marketplace user interfaces, according to an embodiment of the present invention. FIG. 6 illustrates a user experience platform where various users may interact in three dimensions using isometric components. The isometric visualization presents a comprehensive view of a data products ecosystem with multiple interconnected platforms and user roles arranged in a three-dimensional spatial layout.

As shown in FIG. 6, users may include Business Support users such as Shopper, Product Owner, Data & Analytics Team. Users may interact with Platform and Experience using Process Automation and Data Marketplace. Process Automation may include: operational, permission, delivery, deprovisioning, and data management. Data Marketplace may enable searches, product profiles and checkout. Data Product interactions may occur with Data Products (e.g., data storage, file repository, etc.) and Data Delivery (e.g., data viewed, B2B portal, and communications). Governance may support interactions with Data Operations Designer, Governance Board (e.g., steering committee, enterprise data, domain SMEs, data stewards, etc.), Product Portfolio Manager, Data Services (e.g., Generative AI, quality engineering, policy engineering, data catalog, etc.) and Consumer Feedback (e.g., submissions, user reviews, etc.).

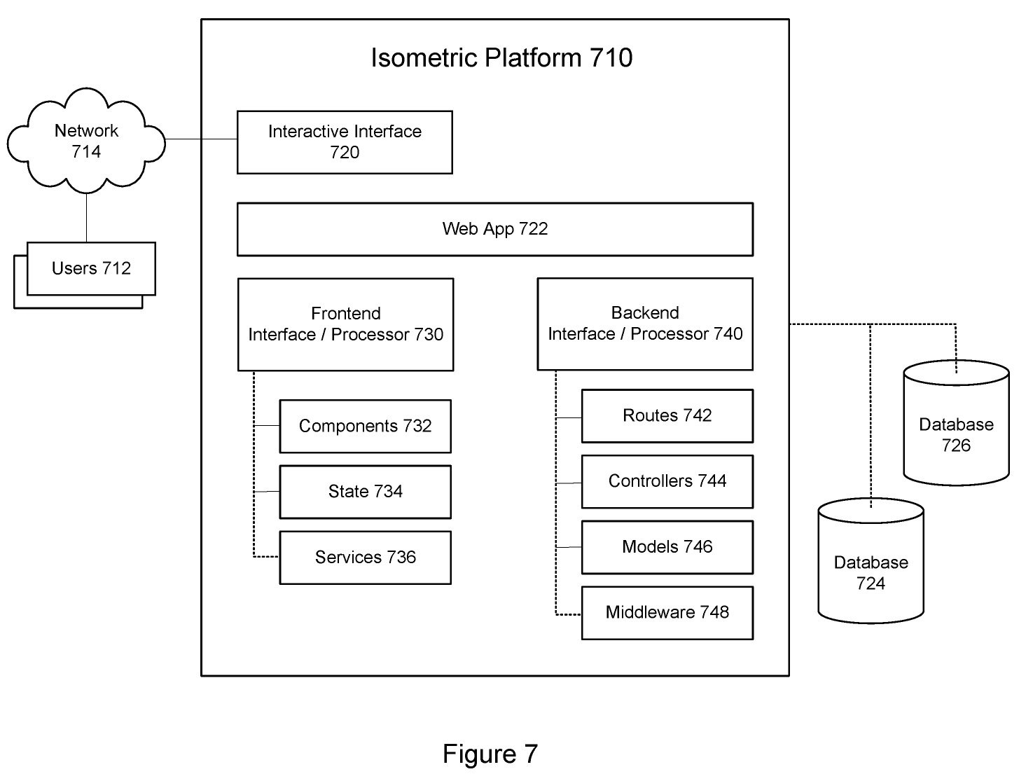

FIG. 7 is an exemplary system diagram, according to an embodiment of the present invention. As shown in FIG. 7, users 712 may access and interact with Isometric Platform 710 through Interactive Interface 720 via a network, as shown by 714, or other communication mechanisms.

Isometric Web App, as shown by 722, represents a tool for various users including sales engineers to present their materials in an interactive way to clients. The tool allows customization of those interactive elements for customization depending on the project.

As shown in FIG. 7, an embodiment of the present invention may include multiple separate repositories as shown by Databases 724, 726.

According to an exemplary implementation, the frontend, shown by Frontend Interface / Processor 730, may be built using React, while a REST API as backend may be implemented using Express.js, typescript, Prisma, and PostgreSQL.

The separation of concerns between the frontend and backend ensures clarity in development, ease of maintenance, and the ability to scale each component independently.

Databases 724, 726 may be responsible for the user interface and user experience aspects of the application. It may leverage React, a popular JavaScript library for building interactive UIs.

In addition, Databases 724, 726 may handle the server-side logic, including data processing, authentication, and API endpoints. It may utilize Express.js for the server framework, Prisma as the ORM for database interactions, and PostgreSQL for data storage. In addition, there may be an integration with Microsoft SSO service for using Active Directory as authentication.

Frontend (React) (as shown by Frontend Interface / Processor 730) may support various technologies including: React: A JavaScript library for building user interfaces; React Router: A library for handling routing in React applications.

Backend (Express.js, Prisma, PostgreSQL) (as shown by Backend Interface / Processor 740) may utilize: Express.js: A minimal and flexible Node.js web application framework; Prisma: A modern ORM that simplifies database interactions; PostgreSQL: A powerful, open-source relational database system; JOI: Validation and sanitization of input data; JWT: JSON Web Tokens for handling authentication and authorization; and Jest: A testing framework for ensuring code quality and reliability.

The System Architecture may be designed to separate the frontend and backend concerns, allowing independent development and deployment of each component.

According to an illustrative implementation, Frontend Architecture, as shown by Frontend Interface / Processor 730, may be built as a single-page application (SPA) using React. It may communicate with a backend API via HTTP requests. The components of the frontend architecture may include: Components 732 (e.g., reusable UI components that form the building blocks of the application); State 734 (e.g., components that connect to manage state) and Services 736 (e.g., modules for making HTTP requests and handling API interactions). The admin may be divided in two separate routes including: Experience that includes the isometric experience, Shopper and Development; and Admin for authorized staff where new isometrics may be created.

According to an illustrative implementation, Backend Architecture, as shown by Backend Interface / Processor 740, may be structured as a RESTful API built with Express.js. Components may include: Routes 742 (e.g., define the API endpoints and handle HTTP requests); Controllers 744 (e.g., business logic and data processing modules); Prisma Models 746 (e.g., manage database interactions using Prisma); Middleware 748 (e.g., handle authentication, logging, error handling, and other cross-cutting concerns); and Database 724 (e.g., PostgreSQL may be used as a primary data store, with Prisma providing an abstraction layer for database operations).

According to an illustrative implementation, Database Design may include a database schema designed to support the application’s data requirements efficiently. Key tables and their relationships may include: Users (e.g., stores user information including authentication); details; Roles (e.g., defines user roles and permissions); Isometrics Experiences (e.g., contains the experiences, and customizations of each one, divided in multiple tables) including Inventory, Narrative and Overlays; Metadata (e.g. adds metadata to the experiences, like tags for easy searchability and management); and Archive Tables (e.g., store old versions of isometrics).

An embodiment of the present invention may be directed to an API Design. For example, a backend API may be designed following RESTful principles, providing clear and consistent endpoints for frontend interaction. Key API endpoints include: users, login, and experiences. The use of HTTP verbs may result into CRUD operations for each resource.

The development workflow may involve the following steps for Frontend Development: clone a frontend repository (or database); install dependencies; start the development server; and make code changes and use hot-reloading to see updates in real time.

For Backend Development, the steps may include: clone a backend repository (or database); install dependencies; set up the PostgreSQL database and configure Prisma in the ENV demo file; start the development server; develop API endpoints and business logic; and write unit and integration tests in case.

According to an embodiment of the present invention, the deployment process may involve deploying frontend and backend components to a production environment. The branch in git “main” may be the one released to production. Additional features may be added using another branch name and then merged after QA approval.

Security features may include: Authentication (use JWT for secure user authentication); Authorization (implement role-based access control to protect sensitive endpoints); Data Validation (validate incoming data to prevent SQL injection and other attacks); Encryption (encrypt sensitive data in transit using HTTPS and specific protections); and Error Handling (implement proper error handling to avoid exposing internal details).

Other implementations, components and services may be used in accordance with the various embodiments of the present invention.

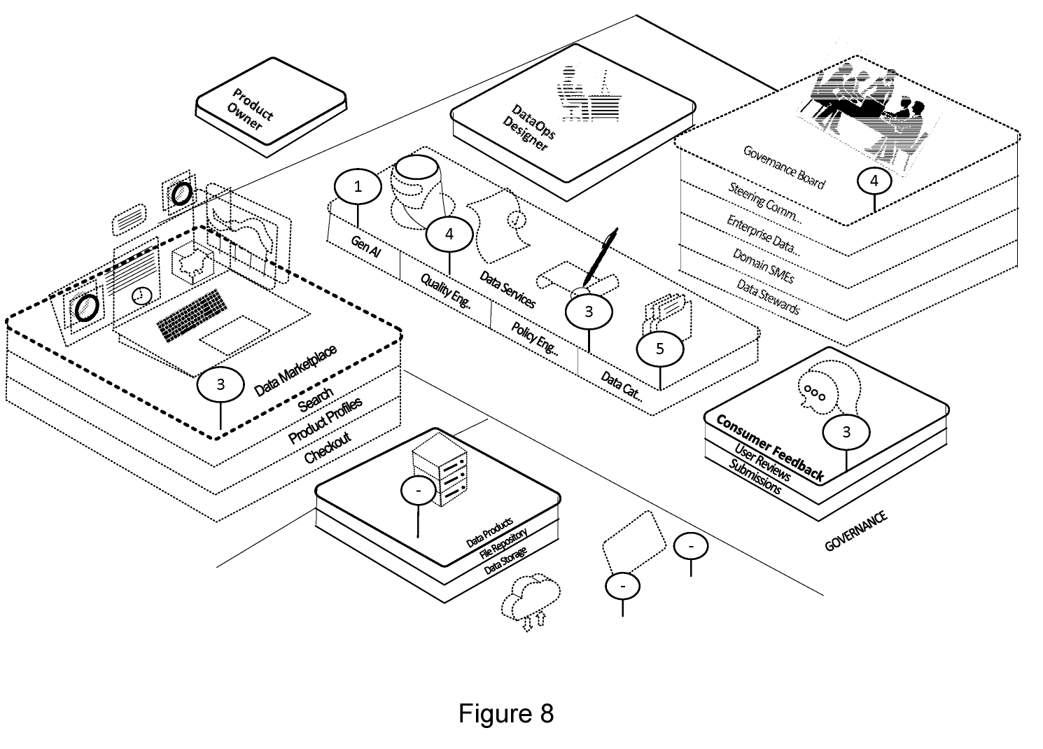

FIGS. 8-11 illustrates exemplary user interfaces, according to an embodiment of the present invention. According to an embodiment of the present invention, the isometric visual may be extended through information layers, allowing for exposure of topic-specific contextual information and reference content. Capability assessment templatization and scoring may be integrated into the isometric experience, pulled through from methodologies for Data Modernization Maturity Assessment. These capability assessments may be customized on a per-client basis, aligned to their areas of focus.

FIG. 8 illustrates an exemplary capability layer with indicator pins and average scores. The interface shows multiple grouped components organized across several platform areas including a Data Marketplace section, a Data Products section, and a Governance section.

The indicator pins are positioned at various locations throughout the isometric view, marking capability assessment points associated with different platform components. An average score indicator may be displayed, providing a summary metric for the capability assessments across the visualization. The capability layer interface enables users to view maturity assessments overlaid on the three-dimensional representation of the marketplace ecosystem.

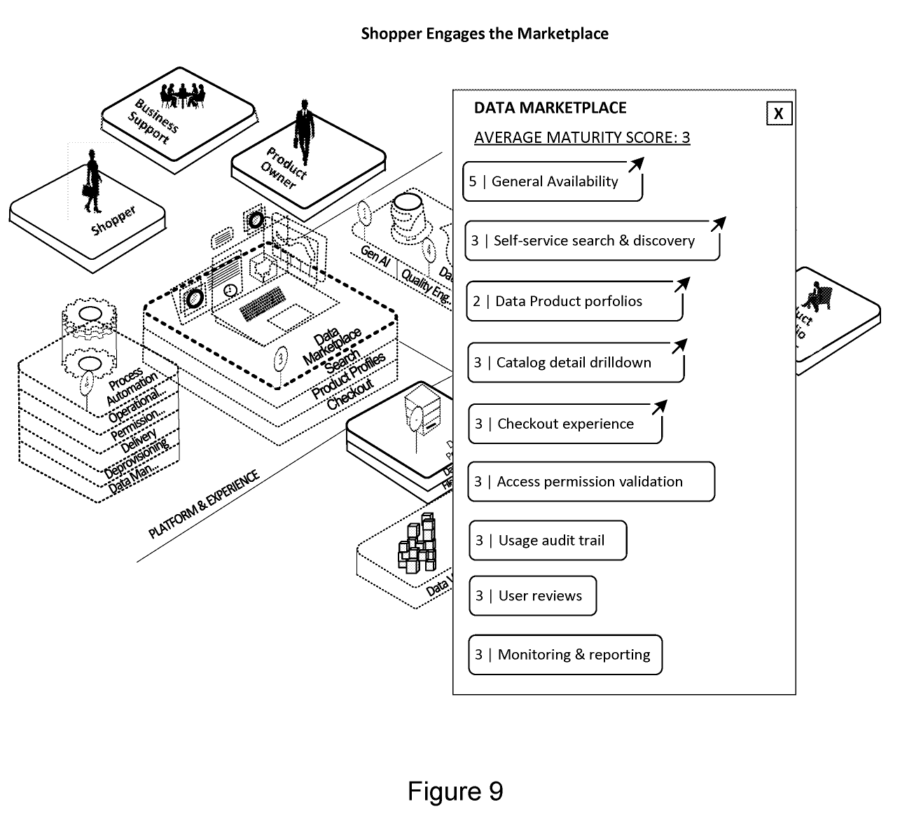

FIG. 9 illustrates an exemplary capability layer popup with capabilities, scores, reference links and average scores. In this example, a shopper may engage with the marketplace. Data Marketplace interface may include an average maturity score (or other metric) with General Availability, Self-service search and discovery, data product portfolios, catalog detail drilldown, checkout experience, access permission validation, usage audit trail, user review, monitoring and reporting.

The interface presents a comprehensive view of the shopper experience within the data marketplace, combining the isometric visualization with an overlay panel that displays capability maturity assessments for various marketplace functions.

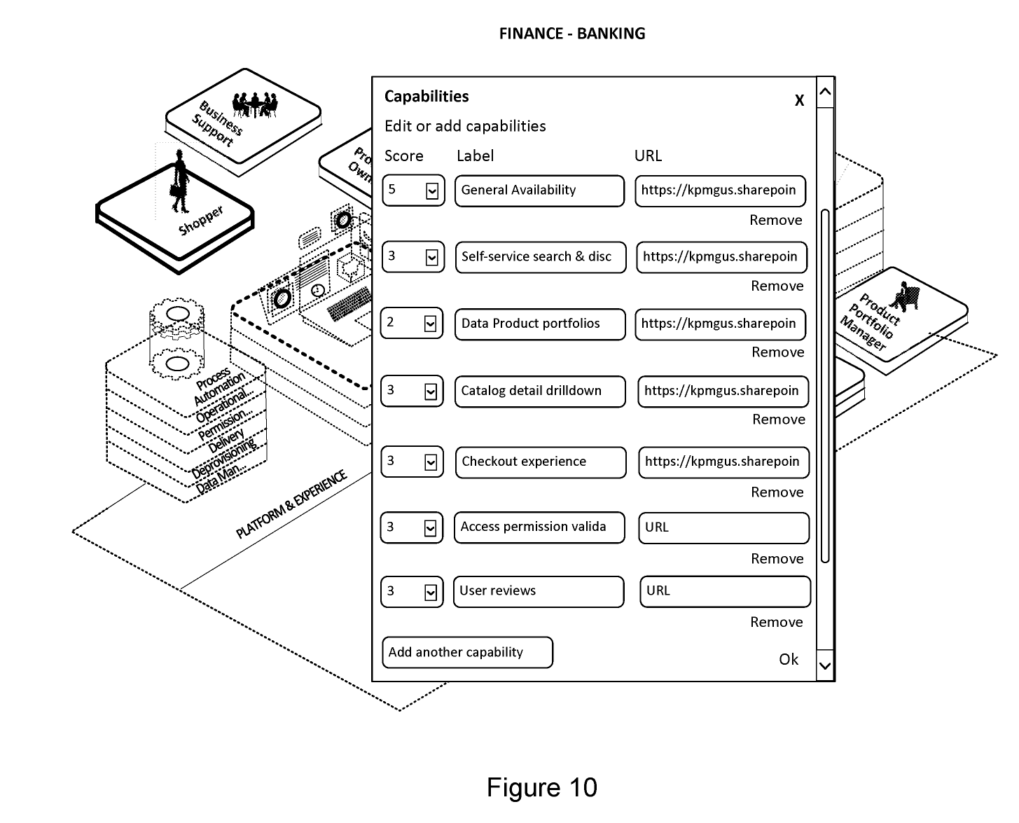

FIG. 10 illustrates an exemplary capability layer editor with add/remove capabilities, reference links and apply scores. In this example, Capabilities interface may enable a user to edit and add capabilities with scores, labels and corresponding URLs.

The interface enables users to manage capability assessments through an editable panel that supports adding, modifying, and removing capability entries associated with platform components.

The capabilities panel includes columns for Score, Label, and URL. Multiple capability entries are shown in the capabilities panel, including General Availability, Self-service search and discovery, Data Product portfolios, Catalog detail drilldown, Checkout experience, Access permission validation, and User reviews. Each capability entry includes a dropdown selector for score, a text field containing a capability label, and a URL field containing reference links to associated resources.

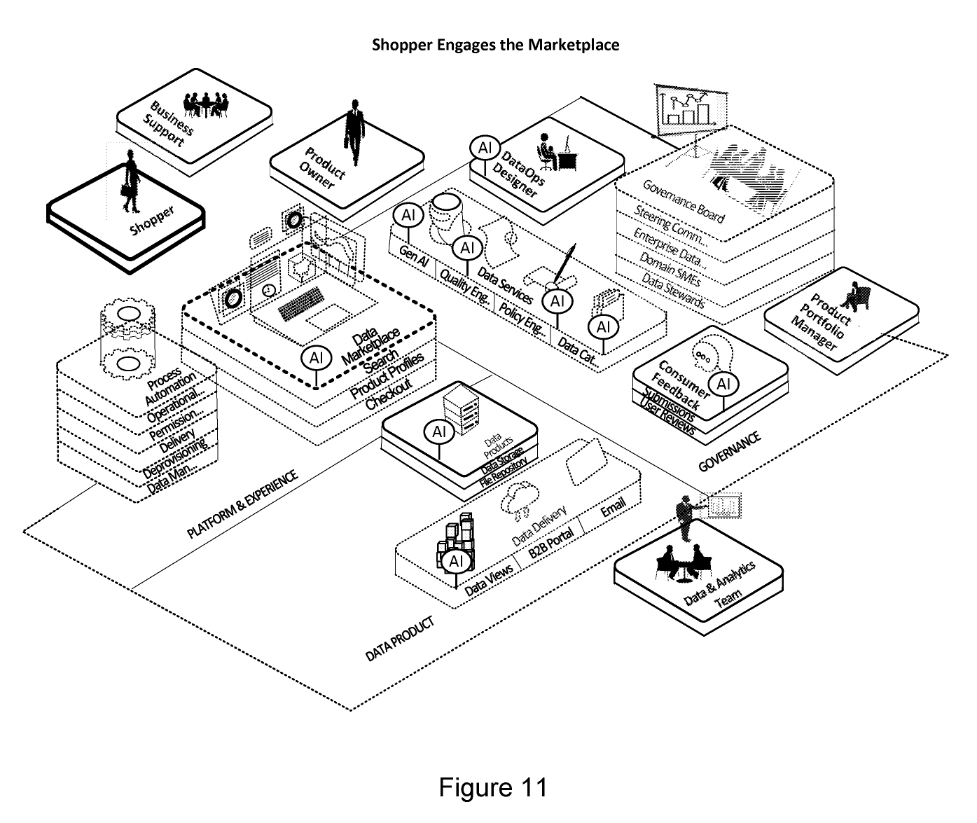

FIG. 11 illustrates an exemplary interface that shows other information layers with AI enabled areas and dedicated pop-up information. In this example, a shopper may engage with the marketplace through interactions with Platform & Experience, Data Product and Governance.

The interface depicts multiple user personas and platform components arranged in a three-dimensional spatial layout that demonstrates the relationships and interactions between various elements of a data product ecosystem. The interface includes multiple AI-enabled indicators displayed throughout the visualization, with dedicated pop-up information associated with AI-enabled areas.

The AI-enabled indicators are represented as visual markers positioned at locations within the isometric view where artificial intelligence functionality is incorporated into platform operations. The pop-up information associated with AI-enabled areas provides details about how artificial intelligence capabilities enhance specific platform functions such as search recommendations, quality assessments, and policy enforcement.

The interface shows several user personas positioned around the platform including Business Support users, a Shopper, a Product Owner, and a DataOps Designer. A Governance Board area displays multiple stakeholders including Steering Committee members, Enterprise Data representatives, Domain SMEs (Subject Matter Experts), and Data Stewards. A Product Portfolio Manager is also depicted within a governance section.

The user interfaces are illustrative only and may support other analytics, graphics and features in accordance with the various embodiments of the present invention.

An embodiment of the present invention provides technical improvements over conventional data management interfaces by rendering complex data product lifecycle information in an interactive three-dimensional isometric visualization that enables users to perceive relationships and dependencies between components, personas, and stages that would be difficult to convey through traditional two-dimensional representations. The three-dimensional spatial arrangement of isometric components provides a technical solution to the technical problem of presenting multi-dimensional data relationships in a manner that reduces cognitive load and enables efficient navigation across information paradigms. The interactive layer system that toggles contextual information overlays across the isometric visualization represents a specific technical implementation that transforms how users interact with and comprehend data product ecosystems.

An embodiment of the present invention further provides technical improvements through the integration of capability overlays that dynamically display metrics and scores across isometric components, enabling real-time visual assessment of platform capabilities. The linking and integration capabilities that connect the interactive three-dimensional interface to external systems such as client data catalogs, master data management systems, and external marketplaces provide technical functionality that extends beyond mere data presentation. The system architecture comprising frontend and backend processors with defined components for state management, routing, controllers, and middleware represents a specific technical implementation for delivering the interactive three-dimensional experience.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

1. A computer-implemented system that implements an isometric three-dimensional interactive interface platform that comprises:
an interactive three dimensional user interface that provides a plurality of synthetic data product isometrics in the isometric three-dimensional interactive interface platform;
a database; and
a computer server that comprises a processor that is communicatively coupled to the interactive three-dimensional user interface and the database and further configured to:
receive, via the interactive three-dimensional user interface, a request for one or more data products;
evaluate, via an evaluate and define stage within the interactive three-dimensional user interface, the request and define the one or more data products;
build, via a development stage within the interactive three-dimensional user interface, the one or more data products and solutions;
certify, via a publish stage within the interactive three-dimensional user interface, the one or more data products;
publish, via the publish stage within the interactive three-dimensional user interface, the one or more data products;
monitor, via the publish stage within the interactive three-dimensional user interface, the one or more data products; and
feature the one or more data products in an interactive Data Marketplace.

2. The computer-implemented system of claim 1, wherein the interactive three-dimensional user interface provides a plurality of information layers that are selectable by a user, the plurality of information layers comprising at least one of: value assessments, technology details, risk indicators, or capability scoring.

3. The computer-implemented system of claim 1, wherein the interactive three-dimensional user interface provides an overlay that displays scores for each capability within an isometric visualization.

4. The computer-implemented system of claim 1, wherein the interactive three-dimensional user interface supports a plurality of user personas comprising at least one of: a requestor, a product portfolio manager, a product owner, a domain subject matter expert, or a product engineering representative.

5. The computer-implemented system of claim 1, wherein the processor is further configured to provide one or more of: customizable text labels, pop-up content, or layer information.

6. The computer-implemented system of claim 1, wherein the evaluate and define stage comprises a standards component that provides guidelines and specifications governing data product development, the standards component comprising at least one of: data product standards, development standards, or enterprise standards.

7. The computer-implemented system of claim 1, wherein the development stage comprises data product components that encompass inputs, delivery mechanisms, content, and governance rules.

8. A computer-implemented system that implements an isometric three-dimensional interactive interface platform, comprising:
an interactive user interface that provides a plurality of data product isometrics in an interactive three-dimensional platform;
a database; and
a computer server comprising a processor communicatively coupled to the interactive user interface and the database, the processor configured to:
engage, via an interactive three-dimensional interface, a data marketplace;
search, via a platform and experience stage within the interactive three-dimensional interface, for one or more data products;
view, via the platform and experience stage within the interactive three-dimensional interface, one or more data product profiles associated with the one or more data products;
add, via the platform and experience stage within the interactive three-dimensional interface, the one or more data products to a checkout interface;
validate, via a data product stage within the interactive three-dimensional interface, for permissibility of product access for the one or more data products;
deliver, via the data product stage within the interactive three-dimensional interface, the one or more data products; and
receive, via a governance stage within the interactive three-dimensional interface, data product feedback and recommendations.

9. The computer-implemented system of claim 8, wherein the plurality of data product isometrics comprise at least one of: real data or synthetic data.

10. The computer-implemented system of claim 8, wherein the processor is further configured to provide AI-enabled search features that allow conversational search phrases and proactive recommendations pushed to users.

11. The computer-implemented system of claim 8, wherein the one or more data product profiles comprise at least one of: a description of a data product, recommended use, user reviews, data quality scores, data lineage, permissible terms of use, schema definition, sensitivity tags, or delivery options.

12. The computer-implemented system of claim 8, wherein the processor is further configured to support a human-in-the-loop approval during a checkout workflow for at least one of cost approvals, license availability, and business-specific rules.

13. The computer-implemented system of claim 8, wherein the governance stage comprises data services including at least one of: generative AI capabilities, a quality engine, a policy engine, or a data catalog.

14. The computer-implemented system of claim 8, wherein the processor is further configured to support linking and integration to external systems comprising at least one of: client data catalogs, master data management systems, or external marketplaces.

15. A computer-implemented method for implementing data product isometrics in an interactive three-dimensional platform, comprising:
receiving, via the interactive three-dimensional user interface, a request for one or more data products;
evaluating, via an evaluate and define stage within the interactive three-dimensional user interface, the request and define the one or more data products;
building, via a development stage within the interactive three-dimensional user interface, the one or more data products and solutions;
certifying, via a publish stage within the interactive three-dimensional user interface, the one or more data products;
publishing, via the publish stage within the interactive three-dimensional user interface, the one or more data products;
monitoring, via the publish stage within the interactive three-dimensional user interface, the one or more data products; and
featuring the one or more data products in an interactive Data Marketplace.

16. The computer-implemented method of claim 15, wherein the interactive three-dimensional user interface provides a plurality of information layers that are selectable by a user, the plurality of information layers comprising at least one of: value assessments, technology details, risk indicators, or capability scoring.

17. The computer-implemented method of claim 15, wherein the interactive three-dimensional user interface provides an overlay that displays scores for each capability within an isometric visualization.

18. The computer-implemented method of claim 15, wherein the interactive three-dimensional user interface supports a plurality of user personas comprising at least one of: a requestor, a product portfolio manager, a product owner, a domain subject matter expert, or a product engineering representative.

19. The computer-implemented method of claim 15, wherein the evaluate and define stage comprises a standards component that provides guidelines and specifications governing data product development, the standards component comprising at least one of: data product standards, development standards, or enterprise standards.

20. The computer-implemented method of claim 15, wherein the development stage comprises data product components that encompass inputs, delivery mechanisms, content, and governance rules.
